(19) United States
(12) Patent Application Publication
(10) Pub. No.: US 2015/0084751 A1
(43) Pub. Date: Mar. 26, 2015

(54) PEST REPELLANT DEVICE FOR VEHICLES

(71) Applicant: Norvel C. Crawford, Northfield, MI (US)

(72) Inventor: Norvel C. Crawford, Northfield, MI (US)

(21) Appl. No.: 14/366,080

(22) PCT Filed: Feb. 13, 2014
(86) PCT No.: PCT/US2014/016185

§ 371 Date: Jun. 17, 2014

Related U.S. Application Data
(60) Provisional application No. 61/850,508, filed on Feb. 15, 2013.

(51) Int. Cl. A01M 29/18; A01M 29/12

(52) U.S. Cl. CPC A01M 29/18; A01M 29/12
USPC 340/384.2

(57) ABSTRACT

A pest repellant device is provided for use in and around vehicles, such as cars, trucks, recreational vehicles and campers, boats, aircraft, and the like. The pest repellant device includes a fluid repellant dispenser and an electronic pest repellant unit, including at least an ultrasonic emitter and an electromagnetic emitter. The fluid repellant dispenser and the electronic pest repellant unit are operable together or in coordinated fashion in order to discourage common pests, such as insects and arachnids, small rodents, and the like, from entering a vehicle, and in particular from entering a field of view of a vehicle operator and creating a distraction or safety hazard. Optionally, the device may include an ion emitter that acts as an air purifier.

### FIELD OF THE INVENTION

The present invention is directed to pest repellant devices and, more particularly, to electronic and scent-based repellant devices for insects, arachnids, small rodents, and the like.

### BACKGROUND OF THE INVENTION

Vehicles such as cars, trucks, motorcycles, motorhomes, watercraft, and aircraft are susceptible to infestation, nesting, or the occasional presence of pests such as insects, arachnids, small rodents, and the like. Such susceptibility may be particularly likely in vehicles where food is consumed by human occupants, such as in cars, trucks, commercial aircraft, and motorhomes, where the presence of food particles and moisture may draw pests into the vehicle interior. The presence of pests may present a major distraction and potential safety risk, particularly when a pest enters the field of view of a person operating the vehicle, and even more particularly, when the person operating the vehicle is fearful or easily disturbed or distracted by the appearance of such pests.

### SUMMARY OF THE INVENTION

The present invention provides a pest repellant device for vehicles, which includes provisions for selectively dispensing a fluid pest repellant, such as in a liquid spray or aerosol form, and which further includes an electronic pest repellant unit that includes both an ultrasonic emitter and an electromagnetic emitter. By dispersing pest-repelling fluid, pest-repelling sound radiation, and pest-repelling electromagnetic radiation, the device is operable to disperse many different types of pests, and to discourage their presence within range of the repellant device, which is typically sufficient to include substantially the entire interior volume of a passenger vehicle such as a car. However, the pest-repelling signals and scent may be concentrated in areas where the presence of pests would be particularly distracting or distressing to a human vehicle operator, such as in the area of a vehicle windshield and dashboard.

According to one form of the present invention, a pest repellant device includes a fluid repellant dispenser and an electronic pest repellant unit, both of which are operable to discourage the presence of pests such as insects or small rodents. The fluid repellant dispenser includes a fluid reservoir for containing a fluid pest repellant, and a conduit that is in fluid communication with the fluid reservoir, for dispensing the fluid pest repellant into a region of the vehicle through an opening formed in the fluid conduit. The electronic pest repellant unit includes an ultrasonic emitter that is operable to emit a pest-repelling high frequency sound, and an electromagnetic emitter that is operable to emit a pest-repelling electromagnetic radiation. The fluid repellant dispenser is operable to cause the fluid pest repellant to flow from the fluid reservoir and along the fluid conduit to the opening formed in the conduit. The ultrasonic emitter, electromagnetic emitter, and fluid repellant dispenser are operable together (simultaneously or in a coordinated manner) or independently from one another, to discourage the presence of insects or small rodents that can detect at least one of the pest-repelling sound, the pest-repelling electromagnetic radiation, and the pest-repelling fluid.

In one aspect, the pest repellant device is substantially self-contained within a main housing that contains the fluid repellant dispenser, the fluid conduit, and the electronic pest repellant unit. An activation switch is mounted on the housing, and is operable to activate at least one of the fluid repellant dispenser and the electronic pest repellant unit.

In another aspect, the pest repellant device further includes a spray nozzle at the opening of the fluid conduit, which is configured to direct the pest-repelling fluid outwardly from the main housing upon activation of the fluid repellant dispenser.

In still another aspect, the fluid repellant dispenser includes an electrical pump that is selectively operable in response to the activation switch. Optionally, the activation switch is operable to selectively energize the electronic pest repellant unit, and the pest repellant device includes a second activation switch that is configured to selectively operate the fluid repellant dispenser.

In a further aspect, the pest repellant device includes an electrical power cord that is configured to be electrically coupled to an electrical system of the vehicle, with the activation switch in electrical communication with the electrical power cord.

In a still further aspect, the pest repellant device includes both an activation switch and a controller that is operable to activate the electronic pest repellant unit and the fluid repellant dispenser at predetermined intervals, in response to the activation switch.

In yet another aspect, the fluid conduit is configured to extend along a portion of an interior of the vehicle.

In a still further aspect, the electronic repellant unit further includes an ion emitter that is operable as an air purifier.

In another aspect, the fluid reservoir contains a fluid pest repellant in liquid form. Optionally, the liquid pest repellant is a citrus-based extract, and the fluid reservoir is a refillable container.

Optionally, the fluid repellant dispenser and the electronic repellant unit are operable independently of one another, such as in response to signals received from the controller.

Accordingly, the pest repellant device of the present invention is operable to repel pests from a vehicle interior in at least three different manners, including by dispersing a pest-repelling fluid, emitting pest-repelling sound, and emitting pest-repelling electromagnetic radiation, each of which is likely to deter at least one common type of pest, such as insects, arachnids, or small rodents. The pest repellant device thus deters such pests from entering a vehicle interior, and may disperse any such pests that may already be present in the vehicle interior. The pest repellant device may also inhibit nesting or other pest activities along or near an exterior of the vehicle. Thus, the pest repellant device reduces the likelihood of distraction or distress to human occupants, particularly during operation of the vehicle when operator distraction may become a safety concern.

These and other objects, advantages, purposes and features of the present invention will become apparent upon review of the following specification in conjunction with the drawings.

### BRIEF DESCRIPTION OF THE DRAWINGS

FIG. 1 is a diagrammatic view of a pest repellant device in accordance with the present invention;

FIG. 2 is an interior elevation view of a vehicle dashboard and windshield region including the pest repellant device of FIG. 1;

FIG. 3 is a top plan view of a vehicle incorporating the pest repellant device of FIG. 1;

FIG. 4 is another interior elevation of the vehicle dashboard and windshield area, shown with a dashboard-mounted pest repellant device in accordance with the present invention;

FIG. 5 is a top plan view of a vehicle incorporating the pest repellant device of FIG. 4; and

FIG. 6 is an enlarged top perspective view of the pest repellant device of FIG. 4.

### DESCRIPTION OF THE PREFERRED EMBODIMENTS

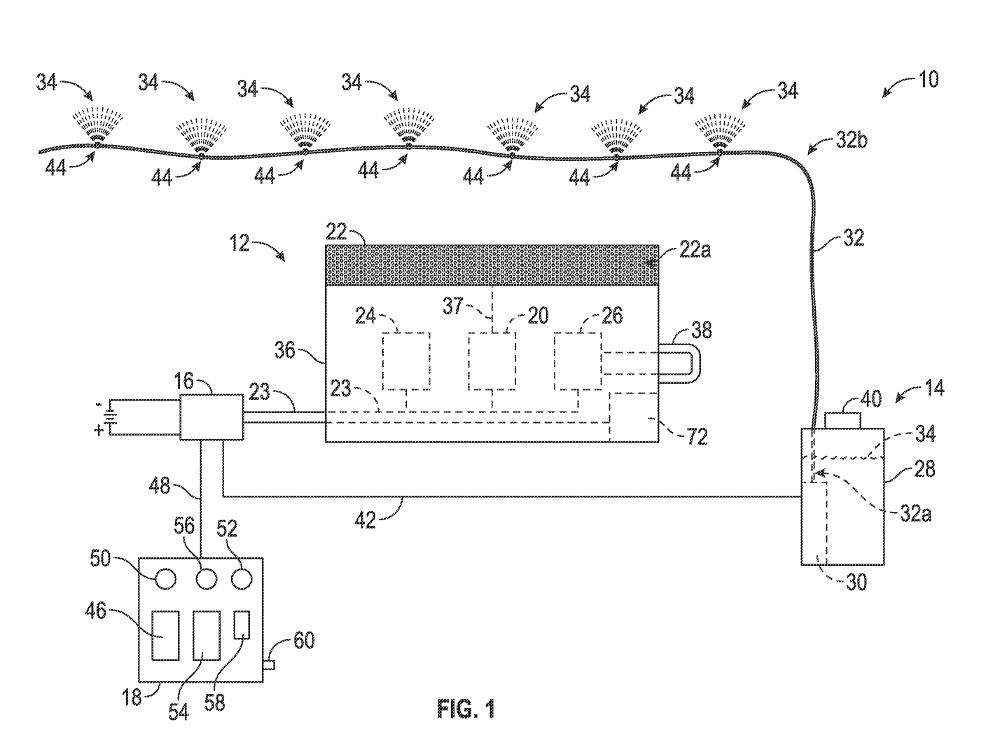

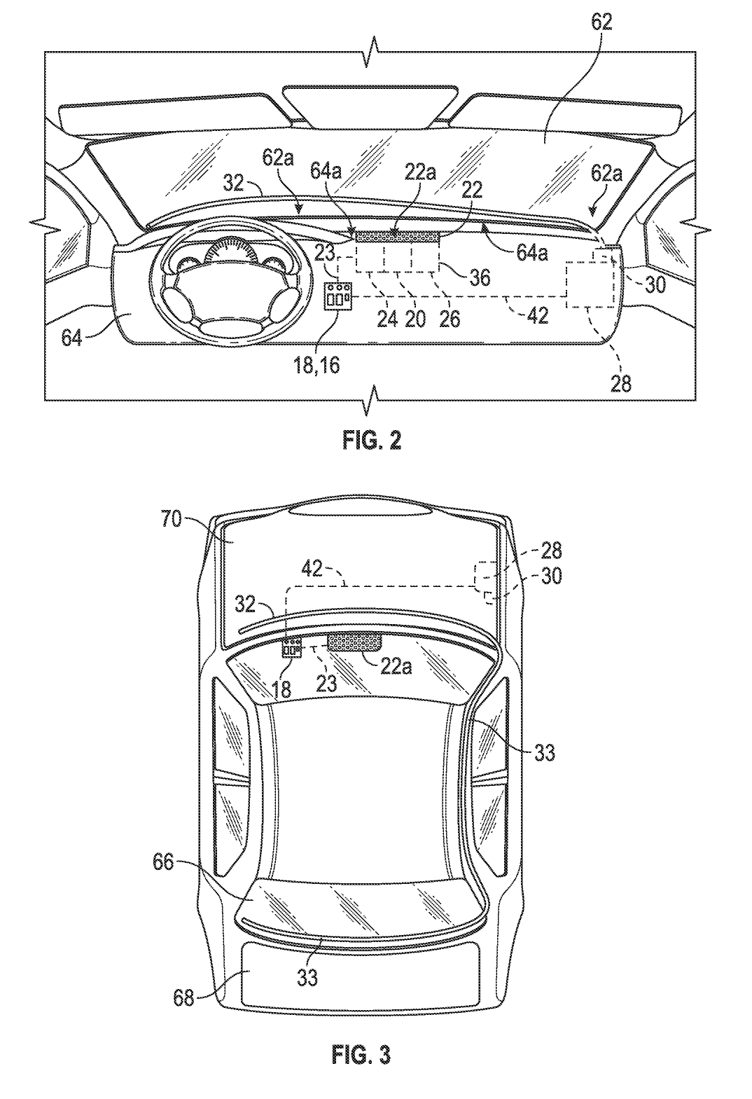

Referring now to the drawings and the illustrative embodiments depicted therein, a pest repellant device 10 includes an electronic pest repellant unit 12, a fluid repellant dispenser 14, a controller 16, and a switching unit 18, such as shown in FIGS. 1 and 2. Electronic pest repellant unit 12 includes an ultrasonic emitter 20 with associated audio speaker 22, and also includes an electromagnetic emitter 24, each of which is selectively activatable by controller 16 via wiring 23, and is operable to discourage the presence of different types of pests. Electronic pest repellant unit 12 optionally includes an ion emitter 26 that is operable as an air purifier. Fluid repellant dispenser 14 includes a fluid reservoir 28, a fluid pump 30, and a fluid conduit 32 through which fluid pump 30 directs a fluid pest repellant 34. Pest repellant device 10 may be installed in a manner in which most of the components are hidden from the view of occupants of the vehicle, except for the switching unit 18 and, in the illustrated embodiment, a grille 22a that is associated with audio speaker 22 (FIGS. 2 and 3). The other components of pest repellant device 10 may be substantially hidden behind vehicle structure.

As will be described in more detail below, electronic pest repellant unit 12 and fluid repellant dispenser 14 are operable independently, simultaneously, or in a coordinated manner, to emit pest-repelling scents, pest-repelling sounds, pest-repelling electromagnetic radiation, to thereby discourage the presence of pests in and around a vehicle, while generally being considered non-lethal to pests. Such pests may include, for example, insects (including bees, flies, and mosquitoes), arachnids (spiders, ticks, scorpions, etc.), and mice, rats, or other small rodents or vermin. For purposes of the description and the claims herein, it will be understood that the term “insects” is used in a broad manner that includes arachnids, while the term “pests” is used to refer to any animal that is sufficiently small to enter a vehicle through various openings that are common to such vehicles, including open windows, wiring or other conduit pass-throughs, and HVAC ducts.

In the illustrated embodiment of FIG. 1, electronic pest repellant unit 12 includes a main housing 36 that contains ultrasonic emitter 20, electromagnetic emitter 24, and ion emitter 26. Audio speaker 22 is electrically coupled to ultrasonic emitter 30 via speaker wiring 37. The speaker may be a separate component that is attached to an outer surface of main housing 36, or may instead be incorporated into a main housing that defines a speaker grille to facilitate the transmission of high pressure ultrasonic sound waves, which are typically emitted at one or more frequencies at about 20 kHz or greater, which can startle and disorient insects. Electromagnetic emitter 24 is operable to emit electromagnet radiation that irritates the nervous systems of insects, arachnids, and small rodents, while confusing insects in a way that makes it difficult for them to gather food, breed, build nests, or communicate with each other, and disorienting rodents and causing them to avoid the electromagnetic radiation source, but substantially without affecting humans, common household pets, or electronics. Ion emitter 26 is operable to destroy airborne pollutants, such as bacteria, dust mites, and the like, and may be in communication with a separate outlet 38 on main housing 36. Additional information on ultrasonic, electromagnetic, and ionic pest control devices that are known in the art may be found, for example, in U.S. Pat. Nos. 5,473,836 and 5,990,783, the disclosures of which are hereby incorporated herein by reference. Ultrasonic emitter 20, electromagnetic emitter 24, and ion emitter 26 are activatable together or independently from one another by controller 16, which in turn may be operated by a vehicle occupant via switching unit 18, as will be described in more detail below.

In the illustrated embodiment of FIG. 1, fluid reservoir 28 of fluid repellant dispenser 14 is a refillable container having a removable cap 40, and is configured to contain and dispense the fluid pest repellant 34 in liquid form. Fluid reservoir 28 contains fluid pump 30, which is at least partially immersed in the fluid pest repellant 34 (FIG. 1). Optionally, the fluid pump 30 may be mounted to the exterior of the fluid reservoir 28, such as shown in FIG. 2. Fluid pump 30 is in electrical communication with controller 16 via pump wiring 42. Fluid conduit 32 includes a proximal end portion 32a that attaches to a fluid outlet of pump 30, with the conduit 32 passing through an opening formed in fluid reservoir 28 and extending outwardly to a distal end portion 32b that includes a plurality of apertures, such as slits or small openings 44, for selectively dispensing the fluid pest repellant 34. Optionally, each opening 44 may be fitted with a spray nozzle that generates a specific desired spray pattern, and may be adjustable between “off”, “wide spray”, and “narrow spray” settings, for example.

Although fluid repellant dispenser 14 is shown and described as including a refillable fluid reservoir 28, it is envisioned that different types of fluid dispensers and/or containers may be used without departing from the spirit and scope of the present invention. For example, compressed air or an aerosol propellant container may be used in a manner that obviates the need for a pump to dispense the fluid pest repellant, which may be stored and/or discharged in either a liquid or gaseous form. Filled and pressurized canisters may be replaced as needed, with the spent canisters being recycled or refilled as desired. An electrically or mechanically operated valve may be used to selectively discharge the pressurized fluid pest repellant at desired intervals, and without need for a separate pump.

Fluid pest repellant 34 may be substantially any substance that discourages the presence of pests, but is not harmful to humans, pets, or the environment, and preferably emits only odors that are generally not considered offensive to humans. For example, all-natural citrus-based compounds may be used, such as extracts of lime, orange, lemon, or grapefruit. Coconut oils or extracts, pineapple extracts, etc. may also be suitable. Preferably, fluid pest repellant 34 does not leave a visible residue as it dries, and is readily cleanable from common vehicle surfaces as desired.

Controller 16 may be operated in various different modes ranging from simple on/off operation that simultaneously activates ultrasonic emitter 20, electromagnetic emitter 24, ion emitter 26, and fluid pump 30 in response to an activation signal received from switching unit 18, to various different automatic or semi-automatic modes in which fluid pump 30, ultrasonic emitter 20, electromagnetic emitter 24, and ion emitter 26 may be operated at predetermined intervals, or operated continuously. Ultrasonic emitter 20 and electromagnetic emitter 24 may be operated substantially continuously as long as controller 16 receives an activation signal from switching unit 18, while fluid pump 30 may be operated at timed intervals to avoid the over-application of fluid pest repellant 34. Optionally, switching unit 18 may be integrated with controller 16, such as shown in FIG. 2. Ion emitter 26 may be operated in conjunction with ultrasonic emitter 20 and electromagnetic emitter 24, or may be operated continuously (e.g., any time that the vehicle ignition is on) to provide a continuous air-purifying function.

Fluid pump 30 may be operated intermittently, such as at 10-minute, 20-minute, or 30-minute intervals (or more or less frequently as desired/needed), to briefly spray fluid pest repellant 34 in the vehicle interior. The time interval and spray duration or volume may be determined by the user, or may be determined by controller 16 based on factors that affect the duration of the fluid pest repellant's effectiveness, such as environmental factors including temperature and humidity. For example, higher frequency dispensing may be needed during periods of higher temperatures and humidity in which insects are more likely to be present and active, while less frequent dispensing (or none at all) may be needed in colder and/or dryer climates where the presence of such pests is less common.

Optionally, fluid repellant dispenser 14 and one or more of the emitters of electronic pest repellant unit 12 may be operated intermittently, or on a predetermined schedule, even when the vehicle ignition is off, to reduce the likelihood that pests will enter the vehicle cabin during times when the vehicle cabin is not occupied or the vehicle is not underway. It is further envisioned that fluid pest repellant 34 may be dispensed at or around a vehicle's exterior surfaces, or in areas around the vehicle, and that ultrasonic sound waves and/or electromagnetic radiation may be directed outside of a vehicle, to further reduce the likelihood that pests will approach or enter a vehicle from the exterior. Thus, pests may be discouraged from nesting along an exterior of the vehicle, such as the undercarriage of a car, truck, or trailer, or in spaces between various components or surfaces of a motorcycle or aircraft, for example.

Switching unit 18 serves as the main interface for an operator of the pest repellant device 10, and is typically mounted in a location that is readily accessible to the vehicle operator. Various switches and indicator lights are provided along switching unit 18 such as shown in FIG. 1, including an on/automatic-mode switch 46 that signals controller 16, via a controller wire 48, to operate electronic pest repellant unit 12 and fluid repellant dispenser 14 in a fully automatic mode. An indicator light 50 provides the user with visual indication that the system is operating in automatic mode. A fluid repellant control knob 52 allows the operator to control the frequency that fluid pest repellant 34 is dispensed through openings 44 and conduit 32. Optionally, the on/automatic-mode switch 46 may activate only the electronic pest repellant unit 12, with a separate fluid control switch 54 enabling the user to directly control the frequency and duration that fluid pest repellant 34 is dispensed.

The activation of fluid pump 30 may be indicated by a pump activation indicator light 56 that illuminates only when pump 30 is actively pumping the fluid pest repellant 34, or that illuminates when pump 30 is operating intermittently on a predetermined schedule. Optionally, a pump-mode switch 58 (FIG. 1) is provided adjacent pump activation switch 54 and enables the user to toggle between a continuous mode in which fluid pump 30 will run and dispense fluid pest repellant 34 through openings 44 as long as pump activation switch 54 is in an “on” position, and an intermittent mode in which pump 30 only operates at predetermined intervals for as long as pump activation switch 54 is in the “on” position. Optionally, a multi-position pump interval switch 60 allows the user to select a predetermined amount of time that will elapse between pump operation intervals. Optionally, indicia may be printed on an outer surface of switching unit 18, at or near the various controls and indicator lights, to indicate the various functions that are controllable via the switching unit 18. Because the scent of fluid pest repellant 34 may be detectable by human occupants of the vehicle, it may be desirable to permit the operator/user to control the frequency and duration that the fluid pest repellant 34 is dispensed, independent of the operation of electronic pest repellant unit 12, which generates ultrasonic sound waves and electromagnetic radiation that are generally undetectable to humans.

In order to ensure sufficient pest-deterrent coverage of a vehicle's interior, it is envisioned that multiple fluid conduits 32, 33 may dispense the fluid pest repellant 34 at different locations within the vehicle, such as shown in FIGS. 2 and 3. Fluid conduit 32 may have sufficient length to reach the area where a lower region 62a of a vehicle windshield 62 meets an upper-forward region 64a of the vehicle dashboard 64 (FIG. 2). Although the fluid conduit 32 is shown in a visible location in FIG. 2, it will be appreciated that distal end portion 32b of conduit 32 may be hidden behind interior trim pieces of vehicle dashboard 64, or may be substantially obscured or placed unobtrusively in a corner region defined between the vehicle windshield 62 and the vehicle dashboard 64. During installation, openings 44 (and optional nozzles) are aimed in a manner that does not direct fluid pest repellant 34 in a direction that would impair the vehicle operator's view through the windshield 62, and in a manner that will not cause the fluid pest repellant to be sprayed or dispensed directly at the vehicle operator, in a manner that would generally not be distracting to the vehicle operator.

As shown in FIG. 3, an optional rear fluid conduit 33 may branch off of the main conduit 32 (or may be attached to a respective fluid outlet of fluid pump 30), so that the fluid pest repellant 34 may be directed along a rear hat shelf 66 (FIG. 3), or to other regions of the vehicle such as under passenger seats, in the vehicle trunk 68 or engine compartment 70, or along the vehicle undercarriage. The size of fluid reservoir 28, and the flow rate and fluid pressure of fluid pump 30, may be selected according to the number of conduits 32 and the number and sizes of openings 44 in the fluid repellant system 14.

It will be also be appreciated that multiple electronic pest repellant units 12 may be placed in various locations throughout the vehicle interior, or even in the vehicle engine compartment 70 or other exterior locations, to ensure that the electromagnetic radiation emitted by electromagnetic emitter 24, and the high pressure ultrasonic sound waves emitted by ultrasonic emitter 20 are effective against common pests in substantially all desired locations in or on the vehicle. For example, conduits 32, audio speakers 22, and electromagnetic emitters 24 may be mounted along a vehicle exterior to discourage pests, including spiders, bees, wasps, mice, and rats from building nests along vehicle surfaces that are accessible from the (or exposed to) the vehicle exterior. Optionally, a single electronic pest repellant unit 12 may include (or may be in electrical communication with) multiple audio speakers, electromagnetic emitters, and ion emitters located throughout the vehicle, to substantially ensure that all areas are within range of the various emitters. Thus, the pest repellant device 10 may be useful even for vehicles that lack an interior, per se, such as motorcycles and all terrain vehicles (ATV's).

Pest repellant device 10 may be hard-wired directly into the vehicles electrical system in a manner that allows it to be powered and operated even when the vehicle ignition is switched off (FIG. 1), or it may be wired so that the pest repellant device may only be operated when the vehicle ignition is switched on. Optionally, the pest repellant device may be powered via a standard 12-volt DC power outlet located in the vehicle, and/or the pest repellant device may be equipped with its own battery 72 (FIG. 1) that allows it to be operated independently from the vehicle electrical system. Optionally, an on-board battery may serve as the sole source of electrical power to the pest repellant device, or such a battery may be used to operate the pest repellant device for a limited period of time after the vehicle ignition has been switched off. Furthermore, battery 72 may be recharged by the vehicle's battery, alternator, or generator during operation of the vehicle.

Pest repellant device 10 of FIGS. 1-3 may be installed as an after-market accessory system, such as by first removing various interior surface panels so that the various components of the device may be placed or routed in relatively unobtrusive locations. However, it will be appreciated that, due to limited space availability behind various panels of a given vehicle, it may not be possible or feasible to install various components of the device, such as the electronic pest repellant unit 12 and the fluid repellant dispenser 14, as aftermarket components within the vehicle dashboard 64 and fully out of view. By altering the lengths of the various wiring and fluid conduits, however, it will be appreciated that electronic pest repellant unit 12 and fluid repellant dispenser 14 may be placed substantially anywhere within the vehicle cabin, and that the fluid repellant dispenser 14 may even be placed in the engine compartment 70 or trunk 68 of the vehicle, without adversely affecting the function of the pest repellant device 10. It is further envisioned that the pest repellant device may be factory-installed during manufacturing of a vehicle, so that the device's various components may be more readily incorporated into the vehicle.

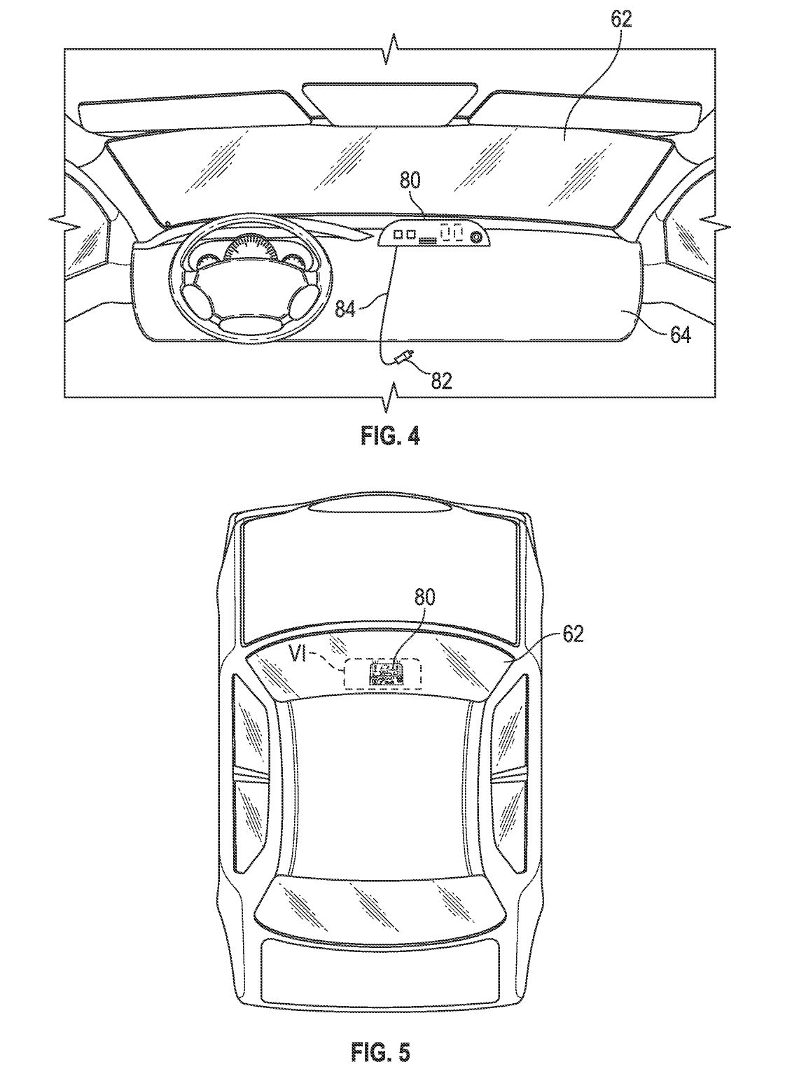

Optionally, and with reference to FIGS. 4-6, a substantially self-contained pest repellant device 80 is designed to be supported directly on the vehicle dashboard 64, and may be battery-powered or powered via a conventional 12-volt accessory plug 82 and associated wire 84 (FIG. 4). Optionally, self-contained pest repellant device 80 includes a rechargeable battery that is charged via accessory plug 82 and wire 84 (which may be detachable from device 80), so that pest repellant device 80 may be operated for extended periods without any external wiring or power connections. Self-contained pest repellant device 80 may provide substantially the same functionality as pest repellant device 10, but can be readily removed from one vehicle and placed in another vehicle, or moved to various different locations within a single vehicle, and does not require any tools or significant labor to install.

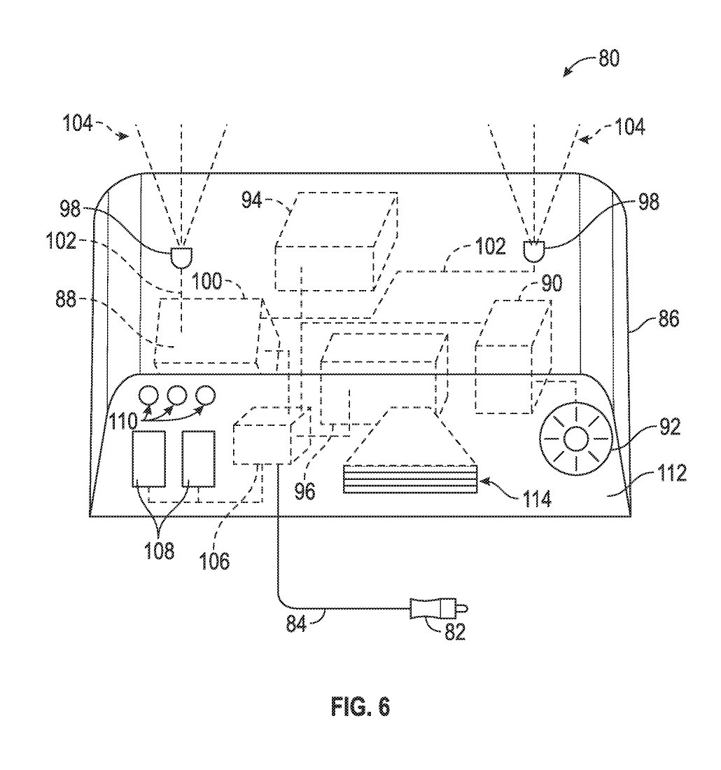

The components of pest repellant device 80 are substantially contained within a housing 86, including a fluid repellant dispenser 88, an ultrasonic emitter 90 with associated audio speaker 92, an electromagnetic emitter 94, and an ion emitter 96 (FIG. 6). Fluid repellant dispenser 88 includes at least one spray nozzle 98 coupled to a fluid reservoir 100 via a conduit 102, and aimed so that a spray of fluid pest repellant 104 is directed rearwardly from housing 86 (such as in a direction toward the front of the vehicle, as shown in FIG. 5). Optionally, an external fluid conduit, such as a flexible rubber or rubber-like hose, may be attached to fluid repellant dispenser 88 (such as via one of the spray nozzles 98) and routed to a desired location of the vehicle, similar to the conduits 32, 33 that are described above.

A controller 106 may provide substantially the same functions as controller 16, described above, and is operated by a user via one or more switches 108 with accompanying indicator lights 110. Housing 86 includes a front panel 112, where switches 108 and indicator lights 110 are mounted, as well as audio speaker 92 and a grille or opening 114 formed in front panel 112 and associated with ion emitter 96. A lower surface of housing 86 may incorporate a high friction anti-skid pad, a hook-and-loop fastener, a magnetic fastener, or the like, for use in securing the pest repellant device 80 along the vehicle dashboard 64. Optionally, fluid repellant dispenser 88 may include a manual pump, such as a diaphragm-type pump having a pushbutton that is accessible at front panel 112 or along a top surface or other surface of housing 86.

Thus, the pest repellant device of the present invention can be implemented within a vehicle, either in a permanent or a semi-permanent installation, or in a portable/removable installation, and used to deter or disperse pests that can cause distress, distraction, or increased safety risks to occupants of the vehicle. By providing at least three modes of pest deterrents, including electromagnetic radiation, ultrasonic sound, and pest-repelling scent, with optional ion emissions to purify the air, the pest repellant device is effective at deterring most types of common pests, from insects and arachnids to small rodents and the like. The pest repellant device may be operated in a fully automatic mode, with or without user-selectable operation parameters, or may be operated in a manual mode, as desired.

Changes and modifications in the specifically-described embodiments can be carried out without departing from the principles of the present invention, which is intended to be limited only by the scope of the appended claims as interpreted according to the principles of patent law including the doctrine of equivalents.

The embodiments of the invention in which an exclusive property or privilege is claimed are defined as follows:

1. A pest repellant device for vehicles, said device comprising:
a fluid repellant dispenser including a fluid reservoir for containing a fluid pest-repellant;
a conduit in fluid communication with said fluid reservoir, said conduit having an opening for dispensing the fluid pest repellant in a vehicle;
an electronic pest repellant unit including an ultrasonic emitter and an electromagnetic emitter;
wherein said fluid repellant dispenser is operable to cause the fluid pest-repellant to flow from said fluid reservoir and along said conduit to said opening; and
wherein said ultrasonic emitter and said electromagnetic emitter are operable in conjunction with said fluid repellant dispenser to emit a pest-repelling sound, a pest-repelling electromagnetic radiation, and the fluid pest-repellant, respectively, which are detectable by insects or small rodents.

2. The pest repellant device of claim 1, further comprising:
a main housing containing said fluid repellant dispenser, said conduit, and said electronic pest repellant unit; and
an activation switch mounted at said main housing, wherein said activation switch is in electrical communication with at least one of said fluid repellant dispenser and said electronic pest repellant unit.

3. The pest repellant device of claim 2, further comprising a spray nozzle at said opening of said conduit and configured to direct the fluid pest-repellant outwardly from said main housing upon activation of said fluid repellant dispenser.

4. The pest repellant device of claim 2, wherein said fluid repellant dispenser comprises an electrically operated pump that is selectively operable in response to said activation switch.

5. The pest repellant device of claim 2, wherein said activation switch is configured to selectively energize said electronic pest repellant unit, said pest repellant device further comprising a second activation switch configured to selectively operate said fluid repellant dispenser.

6. The pest repellant device of claim 2, further comprising an electrical power cord configured to be electrically coupled to an electrical system of the vehicle, wherein said activation switch is in electrical communication with said electrical power cord.

7. The pest repellant device of claim 1, further comprising:
an activation switch; and
a controller that is operable to activate said electronic pest repellant unit and said fluid repellant dispenser at predetermined intervals in response to said activation switch.

8. The pest repellant device of claim 1, wherein said conduit is configured to extend along a portion of an interior of the vehicle.

9. The pest repellant device of claim 1, wherein said electronic repellant unit further comprises an ion emitter.

10. A pest repellant device for vehicles, said device comprising:
a fluid repellant dispenser including a fluid reservoir for containing a fluid pest repellant;
a conduit in fluid communication with said fluid reservoir, said conduit having a distal end portion configured to be positioned remotely from said fluid reservoir, and said conduit having an opening for dispensing the fluid pest repellant in a vehicle, in a location that is remote from said fluid reservoir; and
an electronic repellant unit including an ultrasonic emitter and an electromagnetic emitter;
wherein said fluid repellant dispenser is operable to cause the fluid pest repellant to flow from said fluid reservoir and along said conduit to said opening; and
wherein said ultrasonic emitter and said electromagnetic emitter are operable in conjunction with said fluid repellant dispenser to emit a pest-repelling sound, a pest-repelling electromagnetic radiation, and the fluid pest-repellant, respectively, which are detectable by insects or small rodents.

11. The pest repellant device of claim 10, further in combination with the fluid pest repellant, wherein said fluid pest repellant comprises at least one citrus-based extract.

12. The pest repellant device of claim 10, wherein said electronic repellant unit further comprises an ion emitter.

13. The pest repellant device of claim 10, wherein said conduit comprises a flexible hose that is configured to be routed along an interior of the vehicle.

14. The pest repellant device of claim 13, wherein said conduit is configured to be routed along a windshield of the vehicle and comprises a plurality of said openings for dispensing the fluid pest repellant.

15. The pest repellant device of claim 10, wherein said fluid repellant dispenser further comprises a fluid pump in communication with said fluid reservoir and said conduit, wherein said fluid pump is operable to selectively dispense the fluid pest repellant through said opening in said conduit.

16. The pest repellant device of claim 15, wherein said fluid reservoir comprises a refillable container configured to store the fluid pest repellant in liquid form.

17. The pest repellant device of claim 10, further comprising a controller configured to selectively activate and de-activate said fluid repellant dispenser and said electronic repellant unit.

18. The pest repellant device of claim 17, further comprising a user-actuatable switch for selectively energizing and de-energizing said controller.

19. The pest repellant device of claim 17, wherein said controller is operable to independently activate said fluid repellant dispenser and said electronic repellant unit.

20. The pest repellant device of claim 17, wherein said controller, said fluid repellant dispenser and said electronic repellant unit are configured to be electrically powered by an electrical system associated with the vehicle.

21. The pest repellant device of claim 20, further comprising electrical wiring coupled between the electrical system of the vehicle and said controller, between said controller and said fluid repellant dispenser, and between said controller and said electronic repellant unit.

22. A pest repellant device for vehicles, said device comprising:
a fluid repellant dispenser including a fluid reservoir configured to contain a fluid pest repellant;
a conduit in fluid communication with said fluid reservoir of said repellant dispenser, said conduit configured to extend to a location in a vehicle that is located remotely from said fluid reservoir, and said conduit having an opening for dispensing the fluid pest repellant;
an electronic repellant unit including an ultrasonic emitter, an electromagnetic emitter, and an ion emitter that is operable as an air purifier;
a controller configured to selectively activate and de-activate said fluid repellant dispenser and said electronic repellant unit;
a user-actuatable switch for selectively energizing and de-energizing said controller;
first electrical wiring configured to be coupled between an electrical system of the vehicle and said controller;
second electrical wiring coupled between said controller and said fluid repellant dispenser; and
third electrical wiring coupled between said controller and said electronic repellant unit;
wherein said fluid repellant dispenser is operable to cause the fluid pest repellant to flow from said fluid reservoir and along said conduit; and
wherein said ultrasonic emitter and said electromagnetic emitter are operable in conjunction with said fluid repellant dispenser to emit pest-repelling sound, pest-repelling electromagnetic radiation, and the fluid pest repellant, at least one of the pest-repelling sound, the pest-repelling electromagnetic radiation, and the fluid pest repellant being detectable by insects or small rodents.
